(19) United States
(12) Patent Application Publication
(10) Pub. No.: US 2002/0091623 A1
(43) Pub. Date: Jul. 11, 2002

(54) System and methods for an electronic real estate trading environment

(76) Inventor: Alan F. Daniels, Atlanta, GA (US)

Correspondence Address: Greenberg Traurig, LLP, 12th Floor, 1750 Tysons Boulevard, McLean, VA, 22102, US

(21) Appl. No.: 10/001,198

(22) Filed: Dec. 4, 2001

Related U.S. Application Data
(60) Provisional application No. 60/251,102, filed on Dec. 4, 2000.
(60) Provisional application No. 60/331,634, filed on Nov. 20, 2001.

(51) Int. Cl. G06F 17/60

(52) U.S. Cl. 705/37

(57) ABSTRACT

A system and method which allows real estate investors to realize the liquidity, diversification, real time pricing, low costs, market valuation, and other advantages heretofore associated with investing in stocks, bonds, and commodities. A preferred embodiment of the invention allows a real estate institution representative to list a property with the invention by entering information about the property into a database. This information is validated, and a number of shares is assigned to the property. Once assigned by the present invention, property shares can be traded among investors. The present invention also allows an investor to research properties and to evaluate property attractiveness at various share prices.

This application claims priority from Provisional U.S. Patent Application Serial No. 60/251,102, filed Dec. 4, 2000, and from the Provisional U.S. Patent Application entitled “System and Methods for International Real Estate Securities Exchange”, filed Nov. 20, 2001 by Alan F. Daniels, both of which are hereby incorporated by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of financial investments, and specifically provides a system and methods through which real estate can be traded electronically.

### BACKGROUND OF THE INVENTION

United States investors typically invest in one of four broad categories: commodities, stocks, bonds, and real estate. Bonds are debt instruments issued by a corporation or a governmental entity as a means of financing particular operational needs. United States government bonds are considered to be very secure investments that can be purchased in small increments, making them attractive to individual investors. Shares of stock represent ownership interest in a corporation. Depending on various factors, including economic conditions, market segment, the size of the corporation, and the number of shares issued, stocks are typically seen as investments ranging in volatility from secure to speculative. Corporations typically issue millions of shares of stock, which helps keep the per-share price relatively low, and thus makes stock ownership accessible to individual investors. Commodities, typically considered more speculative than stocks or bonds, involve ownership of tangible resources, such as precious metals, oil, and grains. Although commodities can require a larger investment than individual stocks or bonds, commodities can still be owned for relatively small investments. Stocks, bonds, and commodities have been very attractive to individual investors due to the relatively small amounts necessary to invest in them, and the resulting ability to diversify investments within and among investment categories.

Unlike commodities, stocks, and bonds, investment in real estate has not been readily accessible to individual investors. There are four main reasons that keep individual investors from investing in real estate: high cost, limited liquidity, lack of real-time pricing, and lack of diversification. Most people simply cannot afford to purchase more than one or two pieces of real estate, due to the high costs associated with such purchases. In addition, due to the structure of the current real estate system, selling real estate can be a time consuming process, and many individual investors prefer, and in some cases need, their investments to be more liquid. Ones reason it takes so long to sell real property is that it is often very difficult to gather objective information, such as the value of comparable, neighboring properties, in a timely fashion. The high cost, limited liquidity, lack of real time pricing, lack of diversification, and other factors have typically combined to limit the availability of real estate investments to individuals.

The prior art has attempted to work around real estate investment shortcomings by creating a few different real estate investment vehicles, including real estate syndications, commingled investment funds, and real estate investment trusts. However, each of these real estate investment vehicles has several disadvantages.

Real estate syndications (RES) are typically limited liability partnerships or corporations which purchase real estate. Investors are typically required to make a large initial deposit, or “sponsorship fee,” with the RES, and then they take a partial ownership in the company and its properties. RESs are not typically publicly traded companies, and therefore it can be difficult to find out how well the RES is performing, the properties it owns, and other information from objective sources. This results in a lack of liquidity, and a lack of real-time share valuations. In addition, although a RES may be able to purchase multiple properties, the investments are typically in a specific geographic area, which does not afford much diversification.

A commingled investment fund is similar to a RES, except that it is typically only open to an institutional investor, such as a pension plan or endowment. As with a RES, a commingled investment fund offers poor liquidity and does not offer real-time share valuations. In addition, commingled fund investors have little control over the properties in which the fund invests, or how the fund operates.

A real estate investment trust, or REIT, is a company into which individuals can invest that is dedicated to owning and, in most cases, operating real estate. REITs typically allow investment through stock, and many REIT stocks are traded on the major stock markets. Although REITs have helped make real estate investments more available to the general public, they still suffer from many of the shortcomings of RESs and commingled investment funds. Specifically, REITs do not allow individuals to participate in wholesale investment opportunities, and REIT investors lack control over the properties owned and investments made by the REIT.

Although RESs, commingled investment funds, and REITs have made real estate investment opportunities more available to individual investors, what is needed is a means by which an individual investor can invest in real estate with the liquidity, control, real-time pricing, and diversification available through stock, bond, and commodity markets.

### SUMMARY OF THE INVENTION

Accordingly, the present invention is directed to a system and method for electronically trading real estate ownership interests that substantially obviates one or more of the problems due to limitations and disadvantages of the related art.

An object of the present invention is to provide a means through which real estate investments can be made more liquid.

An additional object of the present invention is to improve the control individual investors have over real estate investments.

A further object of the present invention is to provide real-time valuation of real estate assets.

Still another object of the present invention is to give individual investors access to a more diverse set of real estate investments.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention addresses the specific needs of the real estate investment industry by creating privately labeled electronic marketplaces through which equity ownership in individual real estate assets can be traded. Each marketplace is represented by an approved money manager or investment banking firm. The marketplace is established with a 3-dimensional trading environment, enabling firms to provide various levels of access to the assets traded therein.

Although marketplaces created by the present invention are privately labeled, the marketplaces are interdependent, thereby establishing a global network of real estate investment opportunities. Through such interdependent marketplaces, the present invention creates a globally accessible real estate investment market, similar to a stock market.

In addition to allowing investment in real estate, the present invention provides access to standardized investment information from a single source. The present invention accumulates this information by capturing local economic data and specific property characteristics, which are converted into a standardized, demand based valuation format that greatly streamlines the information gathering process.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 is a block diagram illustrating a process through which new shares are listed with a marketplace, and through which shares are traded.

FIG. 2 is a sample marketplace administrator account access login screen.

FIG. 3 is a sample marketplace administrator introductory screen.

FIG. 4 is a sample marketplace administrator project listing screen.

FIG. 5 is a sample marketplace administrator investor database search screen.

FIG. 6 is a sample marketplace administrator daily marketplace report.

FIG. 7 is a sample marketplace administrator daily revenue report.

FIG. 8 is a sample investor registration screen.

FIG. 9 is a sample software download screen.

FIG. 10 is a sample application initialization screen.

FIG. 11 is a sample screen capture of an introductory screen which may be presented as a user begins to interact with the present invention.

FIG. 12 is a sample investor property search screen.

FIG. 13 is a sample investor search results screen.

FIG. 14 is a sample investor property details screen.

FIG. 15 is a sample investor stored projects screen.

FIG. 16 is a sample investor purchase placement screen.

FIG. 17 is a sample investor purchase execution screen.

FIG. 18 is a sample investor purchase price analysis screen.

FIG. 19 is a sample investor bid information screen.

FIG. 20 is a sample investor sales execution screen.

FIG. 21 is a sample investor sales price analysis screen.

FIG. 22 is a sample investor portfolio review screen.

FIG. 23 is a sample investor trade status screen.

FIG. 24 is a sample marketplace administrator marketplace database search screen.

FIG. 25 is a block diagram illustrating a preferred network architecture through which the present invention can be supported.

FIG. 26 is a block diagram illustrating computer software modules which are implemented in a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

The present invention provides a system and methods through which the low costs, liquidity, real-time pricing, market-driven valuations, diversification, and other positive attributes typically associated with stocks, bonds, and commodities are extended to the real estate market. The present invention accomplishes this by creating an environment in which the functional equivalents of “shares” of an individual property are traded on an electronic “trading floor” through initial offerings, open market trades, and the like. The present invention includes proprietary software and software modules which enable user interaction with the present invention and the trading of interest or shares in real property.

Individual properties must be “listed” by a bank, builder, broker, or other real estate institution associated with the present invention before shares of the properties can be traded. To be listed, a property owner typically contracts with a real estate institution to make shares of the property available in the present invention through a “marketplace” operated by the real estate entity. Multiple marketplaces can exist within the present invention. Marketplaces can be created for each real estate institution that lists properties for trade with the present invention, and a real estate institution may maintain multiple marketplaces.

A preferred embodiment of the present invention allows real estate institutions to create their own, privately labeled marketplaces. To accomplish this, a preferred embodiment stores marketplace names, names of real estate institutions creating marketplaces, marketplace contacts, and marketplace cap types in a database table, and marketplace logos and other user interface elements in a separate table. Although this architecture provides rapid access to graphic user interface elements and to text, it should be apparent to one skilled in the art that alternative marketplace database architectures can be implemented without departing from the spirit and scope of the present invention.

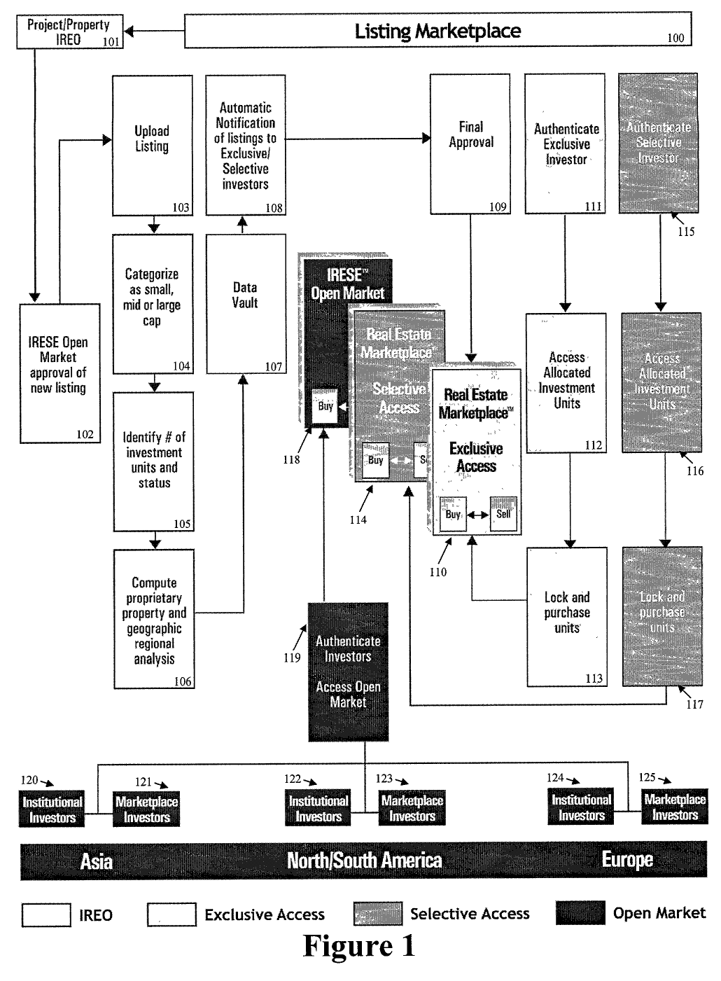

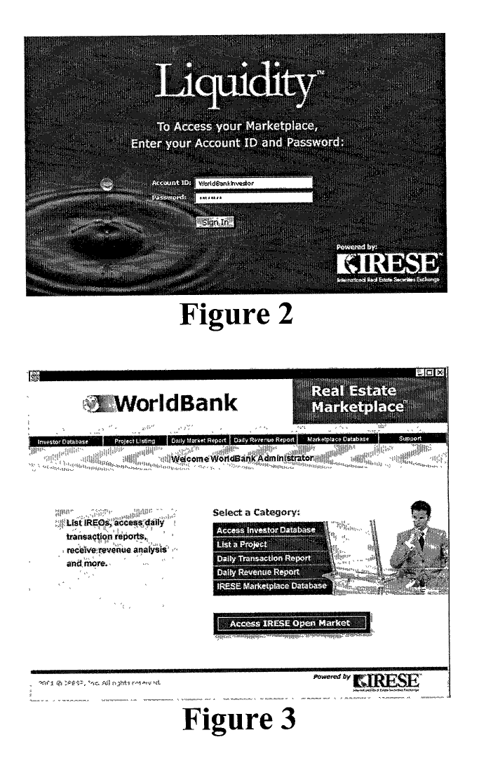

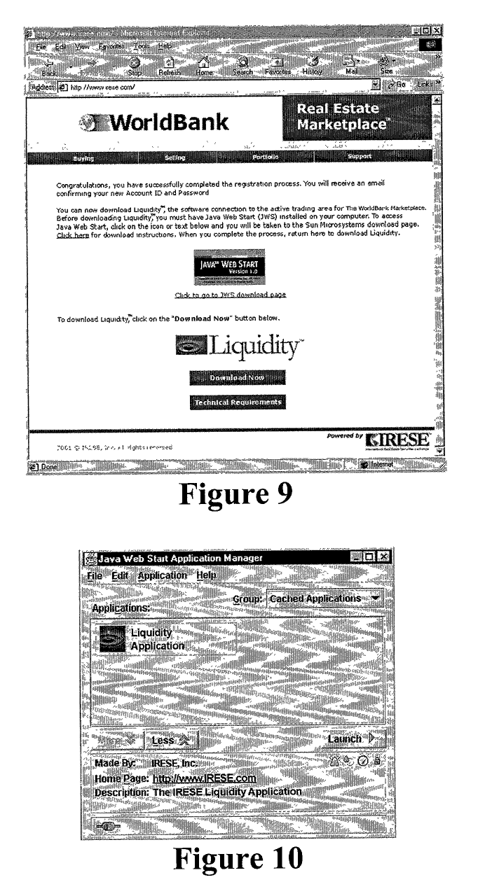

In a preferred embodiment, which will now be described in conjunction with FIGS. 1 through 24, when a real estate institution representative wishes to add a property to a marketplace, the representative should authenticate himself or herself with the present invention by entering a username and password into a login screen, such as the screen illustrated in FIG. 2. Once properly authenticated, the representative will be presented with a screen similar to that illustrated in FIG. 3, which allows marketplace administration.

Features available through a marketplace administration interface such as that illustrated in FIG. 3 include searching the investor database, listing a project in a marketplace, generating marketplace reports, searching all marketplaces, and trading shares on the open market. Market searching, a sample search screen for which is illustrated in FIG. 24, allows a representative to search for properties listed in other marketplaces that meet specific criteria. Representatives can use such a search to identify properties in which they or their clients may be interested in investing. The process by which a real estate institution trades shares on the open market is similar to the process by which an investor trades shares, which is described below.

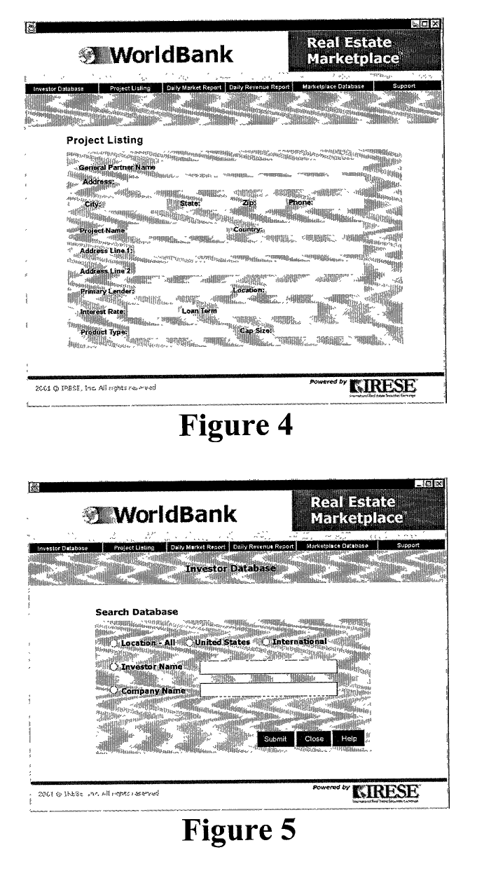

Before shares of a property can be traded, a property must be “listed” with the present invention. In the preferred embodiment illustrated in the Figures, a representative can initiate the listing process by interacting with the “List a Project” user interface element. Interacting with the List a Project user interface element illustrated in FIG. 3 will cause a screen similar to FIG. 4 to be displayed. FIG. 4 is a screen which allows a representative to record pertinent information about the property or project (collectively “property”) being added to the marketplace. Information requested in such a screen, or in a series of such screens, may include, but is not limited to, the name of a general partner or other responsible person who has authorized listing the property with the marketplace; the address of the property; the general geographic region in which the property is located; full and short names for the property; the name of the primary lender on any outstanding loans against the property; loan interest rates; property type; the year the property was built; current occupancy rate; average current occupancy rate for similar property types in the region; rate of return; property revenues; property expenses; net operating income; cash reserves; debit service, cash flow; the property developer; the property manager; and a valuation of the property.

FIG. 1 illustrates a property listing process employed in a preferred embodiment of the present invention. As illustrated in FIG. 1, the process begins when a representative indicates the marketplace with which the property is to be listed and begins entering property information, illustrated as Block 100.

When a representative submits property information to the present invention, illustrated as Block 101, the information is typically approved by the present invention or operators thereof before the property will be made available for trade. This is illustrated as Block 102. Such an approval phase includes a validation of information entered by a representative in Block 100 to insure that such information is accurate. Such validation may include, but is not limited to, searching the property information database for other, similar properties in the same or similar geographic regions and comparing the occupancy rates, rate of return, revenues, and expenses of such properties with information provided by a representative. Other data, such as information collected by industry trade groups, lenders, or other sources, may also be used during the validation step.

Once approved, this information is stored in the present invention in at least one database table, as illustrated by Block 103. In a preferred embodiment, this information is broken into at least three tables, a property table, a detail table, and a financials table. A property table can contain general information about the property, such as, but not limited to, its location, the lender, the marketplace from with it was originally offered, and the property type. A detail table can contain more detailed, static information about the property, such as the year the property was built, the developer, and the like. A financials table can contain financially oriented information about the property, such as, but not limited to, rate of return, property revenues, and net operating income. Such an architecture is preferred because it allows for rapid data search and retrieval while limiting data throughput. While the above described property database architecture is preferred, it should be apparent to one skilled in the art that alternative architectures can be employed without departing from the spirit and scope of the invention, including storing property information in alternative data storage means.

When property data has been stored in appropriate database tables, the present invention can categorize a property based on market value, as illustrated by Block 104 of FIG. 1. In a preferred embodiment, properties may be divided among three categories, small cap, medium cap, and large cap. The present invention can then allocate an initial number of shares to a property, as illustrated in Block 105 based on a property's cap size. Small cap properties, which are properties valued under $25,000,000, are preferably allocated 3,000,000 shares. Medium cap properties, whose values typically range from $25,000,000 to $50,000,000, can have 6,000,000 shares allocated to them. Large cap properties, whose values are typically above $50,000,000, may be allocated 9,000,000 or more shares allocated. By allocating shares in this manner, the present invention allows initial per-share prices to be affordable, even to individual investors.

As illustrated in Block 106, the present invention can also calculate property and geographic region analyses. Such analyses may pull together relevant information from disparate sources such as, but not limited to, local and international news reports, state department briefings, business analyst reviews, local and national industry trade group reports, and developer-provided information. This can help investors better evaluate a property before buying or selling shares of the property.

The information generated in Blocks 104, 105, and 106 is then stored in the present invention, as illustrated in Block 107. In a preferred embodiment, such information is stored in separate tables.

When a representative lists a new property with the present invention, the representative can also specify whether initial share sales are to be restricted to an exclusive group, a group of selective investors, or to the entire set of investors. In addition, when exclusive groups or groups of selective investors are specified, the present invention allows a representative to specify the minimum and maximum number of shares any investor may purchase from the initial offering.

In a preferred embodiment, exclusive groups consist of only those investors who are clients of a given marketplace, or a subset thereof. Exclusive groups allow representatives to make new properties, which may be perceived as good investments because of their valuation, available exclusively to investors associated with a specific marketplace.

Representatives can allow a limited group of non-associated investors to purchase initial shares of a property by offering the property as a “select” property. A preferred embodiment of the present invention allows the representative to select from among investors represented by other marketplaces those investors to whom the initial offering is to be made available. A representative may directly select such investors, if the representative knows an investor's name, or a representative can search for investors who might be interested in a new property. Such searches may be facilitated through a screen similar to FIG. 5.

If a property is listed as an “open market” offering, any user or institution may purchase shares of the property. Although this gives the marketplace less control over initial share distribution, it can place shares into distribution faster which may, in turn, increase each share's value. Shares of properties already listed with the present invention are also traded as open market shares.

As illustrated in Block 108 of FIG. 1, as new properties are listed, the present invention may notify the set of users to whom a property is offered that the property will be available. Such notifications may include information about the investment in the body of the message, and the notifications may provide hypertext links or other references to additional information for those investors interested in the property. In a preferred embodiment, a representative may review and approve the notifications generated in Block 108 before the notification is distributed, and can approve the property for trading.

To receive new share notifications, and to trade stocks generally, investors must be registered with a marketplace maintained in the present invention. Each marketplace can have a set of requirements which an investor must meet before he or she can trade stocks under that marketplace. Investors wishing to register with a marketplace can contact a marketplace representative, or investors can visit a world wide web page associated with that marketplace.

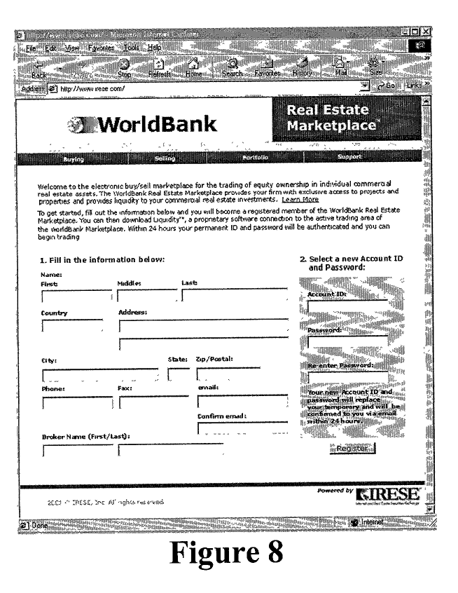

In a preferred embodiment, investor registration is handled through a form similar to that illustrated in FIG. 8. When submitted to the present invention, such information may be stored in a database table.

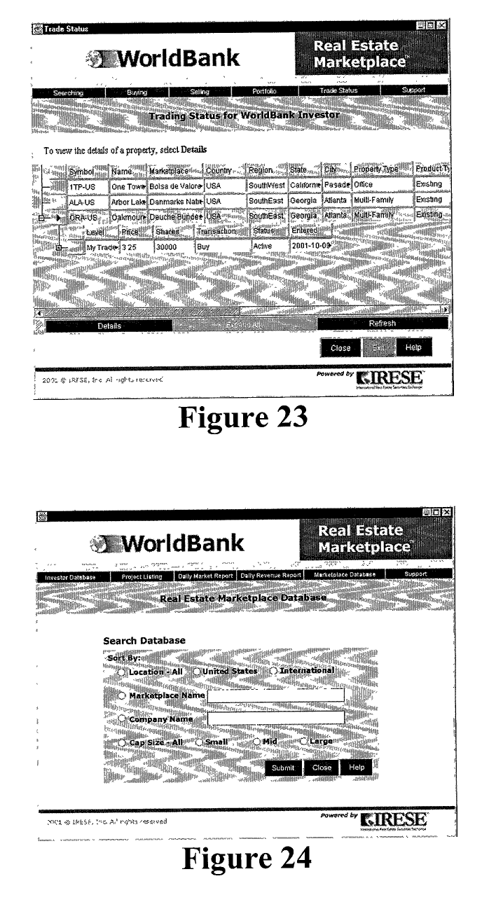

When a new investor registers with the present invention, the present invention can also create a portfolio for that user. A portfolio lists the number of shares bought, the price the shares were bought, the status of those shares, the date and time the shares were bought, and other such information. Within a portfolio, a trading status can indicate whether shares originated in the marketplace with which the investor is associated or from another marketplace. FIGS. 23 and 24 illustrate sample screens for presenting such portfolio information to an investor as the investor interacts with the present invention.

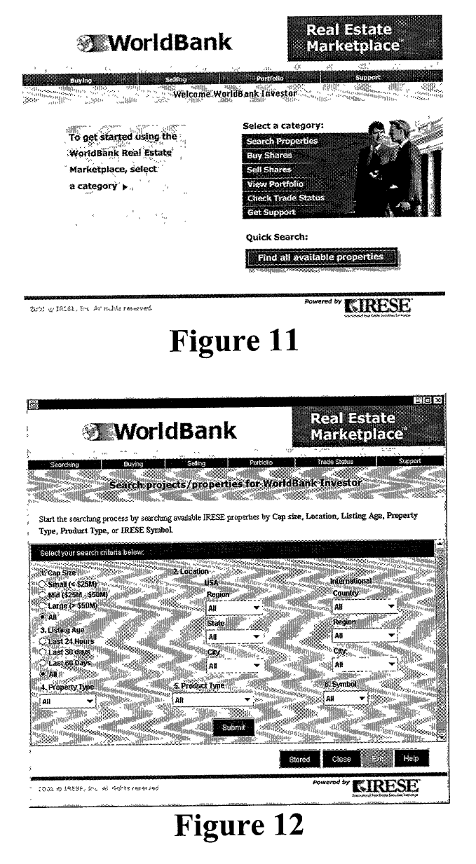

When an investor has finished registering with the present invention, he or she may be presented with a screen similar to FIG. 10. FIG. 10 allows an investor to download software necessary to research properties, trade shares, view account status, and other such investor activities. In a preferred embodiment, such software is written in the Java programming language, and may require an application manager, such as that illustrated in FIG. 11, to start the software.

Once necessary software is installed on an investor's computer, an investor can enter authentication information and gain access to his or her marketplace account through a screen similar to FIG. 12. As FIG. 12 illustrates, such a screen can allow the investor to search for properties, buy shares, sell shares, view their portfolio, check the trading status of the marketplace, find available properties in the marketplace and in the open market, and perform other such functions. One aspect of the present invention not illustrated in FIG. 12 is the ability for an investor to add funds to his or her account. To do this, he or she transfers money to a marketplace, and receipt of such money can be recorded in an investor's portfolio. Such funds are typically necessary before shares can be purchased or traded.

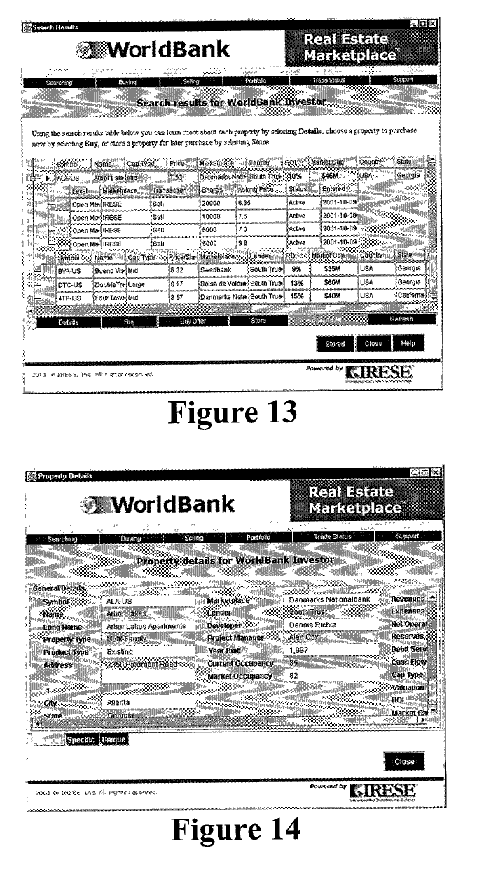

An investor who has deposited money in his or her account is likely to want to research properties listed with the present invention before making any investments. A search screen, such as that illustrated in FIG. 13, can help an investor to find properties meeting general or specific criteria. As FIG. 13 illustrates, a preferred search screen embodiment includes, but is not limited to, the ability to search for properties by cap size, location, listing age, property type, product type and/or symbol.

Properties meeting an investor's criteria may be displayed on a screen similar to that illustrated in FIG. 14. As FIG. 14 illustrates, property information may be displayed in a multi-tier, hierarchical format based on a selected grouping criteria. Each tier level can present additional information about a property or set of properties. In a preferred embodiment, information presented in a top search result tier includes a property symbol, property name, cap type, share price, marketplace, lender, rate of return, market cap, valuation, outstanding shares, total shares, current price, date listed, date last modified, non exclusive date and status. Information presented in a preferred second tier includes recent transaction types, number of shares, price, status, and date entered.

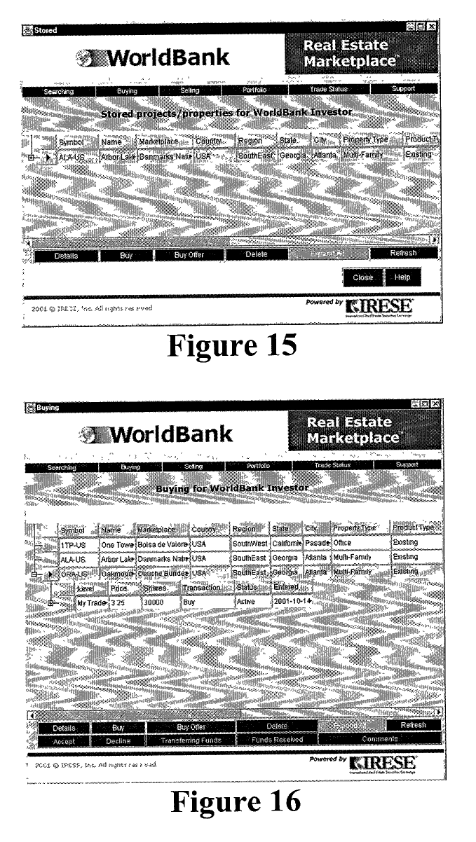

All information associated with a given property can be viewed in a screen similar to FIG. 15 by interacting with a user interface element such as the Details button of FIG. 14. As FIG. 15 illustrates, a preferred property information screen can separate property information into three different categories, general, specific, and unique. General property details include a property symbol, name, long name, property type, address, city, state, zip, region, country, marketplace, lender, developer, project manager, year built, current occupancy, market occupancy, revenues, expenses, net operating income, reserves, debit service, cash flow, cap type, valuation, rate of return, market cap, outstanding shares, status, price per share, total shares, issued shares and current price. Specific details include the gross square footage, rentable square footage, acres, parking type and parking spaces. Unique details include data specific to the type of property selected or to the property itself.

As FIG. 16 illustrates, an investor can return to a property information screen more quickly by adding a property to a “stored properties” page. From a screen such as that illustrated in FIG. 16, an investor may view property details, shares may be bought, a buy offer may be placed, or properties may be deleted from the stored properties list.

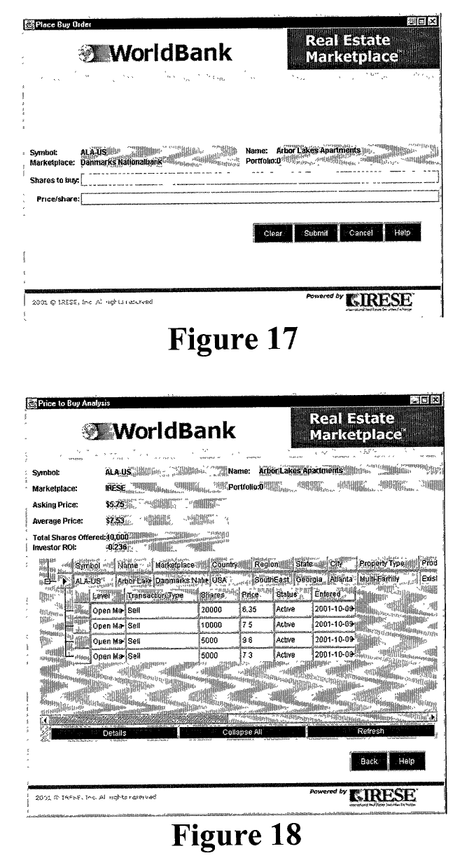

Referring again to FIG. 1, authenticated, registered users, represented by blocks 111, 115, and 119, can receive notifications when new properties are listed with a marketplace. An investor who is a member of an exclusive group or who has been granted selective access to a property can place a buy order for such a property through a screen similar to FIG. 17. Such a screen also allows investors not part of an exclusive group or granted selective access to a property to initiate buy offers, delete a completed transaction, accept a sell offer, decline a sell offer, specify that finds are being transferred, enter comments, or complete a transaction, except as otherwise restricted by the present invention.

An investor who owns shares in a property may typically resell those shares to any other investors who have accounts with the present invention, regardless of the marketplace with which the buyer or seller is associated. By way of example, without intending to limit the present invention, user A, who is associated with marketplace Z and who purchases exclusive shares of property P from marketplace Z, can sell his shares to user B, even though user B is associated with marketplace Y. However, in a preferred embodiment, user A may be limited from such a sale until marketplace Z has sold all of its initially offered shares of property P.

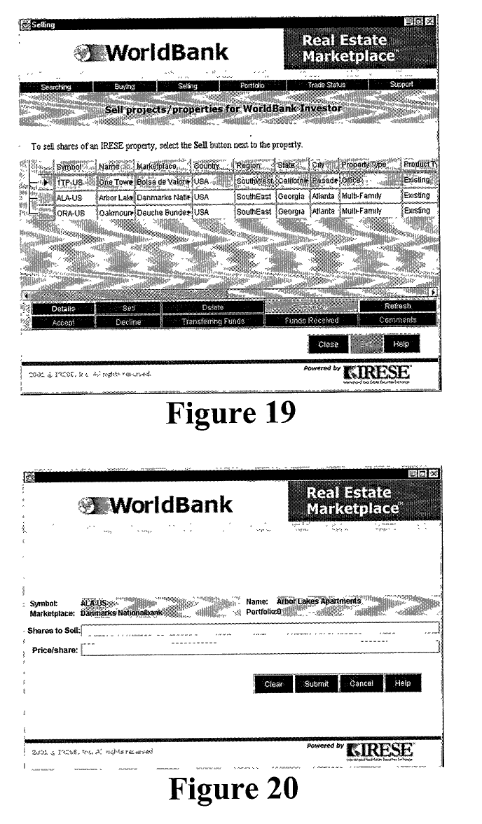

In a preferred embodiment, share transactions between investors are initiated by an investor placing a buy offer. Although buyer-initiated transactions are presently preferred, it should be apparent to one skilled in the art that seller-initiated transactions can be substituted for, or implemented concurrent with, buyer-initiated transactions without departing from the spirit or scope of the present invention. Buy offers are entered through a screen similar to FIG. 18. A buy offer allows an investor to indicate a desire to purchase a number of shares at a particular bid price. Once the number of shares to be purchased and the bid price are entered in FIG. 18, an investor may generate a price to buy analysis, such as that illustrated in FIG. 19, before submitting the offer to the trading floor. In a preferred embodiment, a price to buy analysis can show a rate of return based on a property's cash flow and asking price, or other useful analytical information.

Buy offers placed on a trading floor can be presented to all shareholders through a screen similar to FIG. 20, and shareholders may choose to accept or decline offers through such a screen. Sellers can evaluate buy offers by requesting a price to sell analysis. Such an analysis may be presented through a screen similar to FIG. 22.

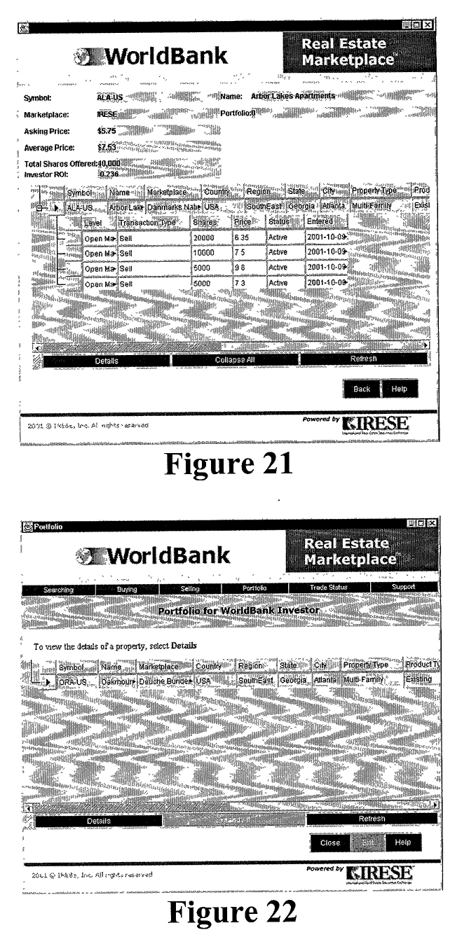

When a seller accepts a buy offer, the seller can use a screen similar to FIG. 21 to insert information necessary for any stock and fund transfers. A buyer confirms that a funds transfer is to occur, and, once properly transferred, a seller confirms that the funds have been received. Ownership of sold shares is then transferred to a buyer, as well as a certificate authenticating the transaction. The transaction is then removed from the trading floor if the number of shares purchased meets the number of shares in the buy offer. If the buy offer was for more shares than purchased from the seller, the buy offer is modified to reflect the difference between the number of shares in the buy offer and the number of shares purchased, and the buy offer remains on the trading floor. In a preferred embodiment, fund transfers, share transfers, and associated authentication processes may be handled automatically by the present invention.

To facilitate rapid transaction processing, fund transfers, and share transfers, a preferred embodiment of the trading floor is implemented as a database table. As properties are offered for trade, a record can be created in the trading floor table reflecting the offer. A preferred trading floor table includes fields in which a unique trade identifier, an identifier associated with a trader, a property identifier, the number of shares to be traded, the bid price of each share, a trade type, a trade status, and a time at which a trade is completed are stored.

As sellers accept bids, the present invention can store the accepted bids in a trading floor transaction table. A preferred trading floor transaction table can contain fields in which a transaction identifier, an identifier associated with the buyer or buyer's proxy, the type of bid, the trade identifier associated with the bid, the number of shares sold, the sale price of the shares, the status of this transaction, any comments for this particular transaction, a timestamp signifying when the transaction was completed, and other pertinent information are stored.

Through such a transaction table architecture, the present invention can quickly process new bids and bid acceptances. The architecture also permits logging of all transactions for security and billing purposes.

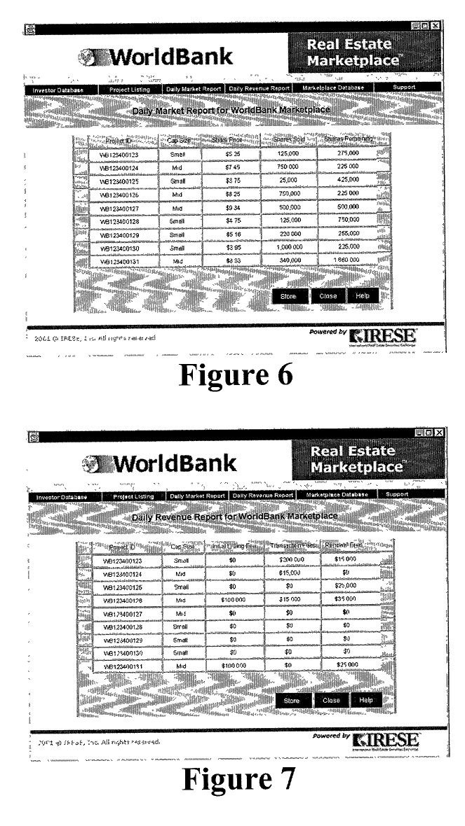

Another advantage of the transaction table architecture is the ability to quickly and easily generate transaction summary reports. Real estate institutions are typically interested in tracking share activity within their marketplaces. The present invention can provide multiple reports to a real estate institution, including daily market reports and daily revenue reports, as illustrated in FIGS. 6 and 7, respectively.

A daily market report provides information on transactions that occurred which pertained to properties initially offered for sale through a given marketplace. Such a report may include the property's name or identifier, symbol, lender, country, region, state, city, property type, product type, cap type, rate of return, market cap, valuation, outstanding shares, total shares, current price, date listed, date and time last modified, non exclusive date, and the like.

A daily revenue report lists revenues made by a marketplace as a result of listing properties in a marketplace. Such a report may include a property name or identifier, symbol, lender, country, region, state, city, property type, product type, cap type, rate of return, market cap, valuation, outstanding shares, total shares, current price, date listed, date last modified, non exclusive date, total shares traded, average price traded, total amount traded, and other such information.

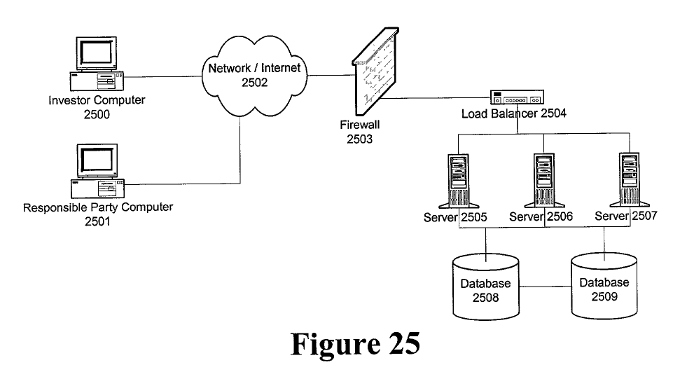

FIG. 25 illustrates a server architecture capable of supporting the present invention. Block 2500 represents a desktop computer, handheld computer, laptop, cellular telephone, or other electronic computing device capable of transmitting and receiving data from other devices which is used by an investor. Such an electronic computing device can be used to register with the present invention, review properties listed in one or more marketplaces, buy and sell shares of properties, and the like. Block 2601 represents an electronic computing device that can be used by a representative associated with a real estate institution or marketplace. Such a computing device can be used for marketplace maintenance, including, but not limited to, adding or removing properties, adding or removing users, and viewing marketplace reports; buying and selling shares; and for other such purposes.

Block 2502 represents the Internet or another communications means by which an investor electronic computing device and a representative computing device can communicate with other aspects of the present invention. Block 2503 represents a firewall or similar security mechanism for controlling access to portions of the present invention. Block 2504 is a load balancer or similar device that ensures rapid responses to user and representative communications by distributing requests from users and responsible parties among servers acting as part of the present invention. Blocks 2505, 2506 and 2507 represent servers on which software necessary to implement a trading floor, one or more marketplaces, and other aspects of the present invention can be run. Blocks 2508 and 2509 represent databases in which user, property, and other information can be stored. As illustrated in FIG. 25, a preferred embodiment of the present invention implements a redundant database configuration, which allows either of the databases to be taken down for maintenance without making the entire invention unavailable.

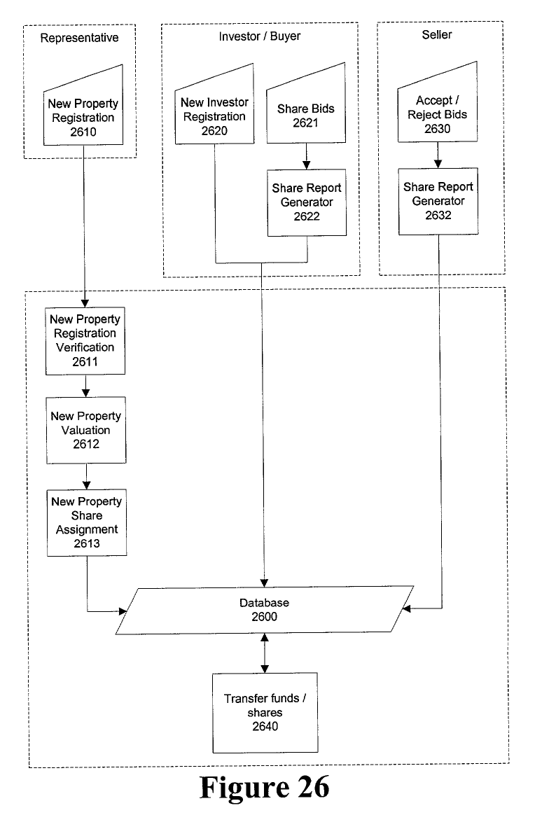

FIG. 26 is a block diagram illustrating preferred software modules implemented in the present invention. Although FIG. 26 represents presently preferred software modules, it should be apparent to one skilled in the art that additional software modules may be added to, and software modules substituted within, the diagram illustrated in FIG. 26 without departing from the spirit or scope of the invention.

Module 2610 represents a user interface through which a representative can list a new property with the present invention. Module 2611 represents a computer software module which can verify property information entered in Module 2610 by cross-checking it against information stored in a database (Module 2600) and by communicating with external entities (not illustrated) such as, but not limited to, lenders and developers. Module 2612 represents a computer algorithm through which a value is assigned to a new property. Module 2613 represents a computer algorithm through which a quantity of shares is assigned to a new property.

Module 2620 represents a user interface through which a new investor can register with a marketplace. Information entered by a new investor can be subsequently stored in Module 2600. Once registered, an investor can research and bid on shares through other computer interfaces, illustrated as Module 2621 and 2622. Investor bids can be stored in a trading floor table within Module 2600.

Share owners can review and either accept or reject bids through Module 2630. Share owners can also generate share reports through Module 2632. If a share owner decides to sell some or all of his shares to another investor, this can be recorded in Module 2600.

When both a seller and a buyer have approved the sale of shares, funds and shares may be transferred between a buyer and seller, as illustrated in Module 2640. The transfer is then recorded in the appropriate investor portfolios in Module 2600.

Through the server architecture, database architecture, and user interface elements disclosed, the present invention provides a system and methods for the trading of real estate shares. The system and methods of the present invention provide the liquidity, real time pricing, market-driven valuations, ability to diversify investments, and other advantages of stock, bond, and commodities markets to the real estate for the first time.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method by which ownership interests in real property can be traded, comprising the steps of:
collecting a plurality of information about a property;
storing said plurality of property information;
analyzing said plurality of property information;
assigning a plurality of shares to said property based upon said analysis;
registering a first user by collecting a plurality of user information from them;
registering at least one additional user by collecting a plurality of user information from them;
allowing said first registered user to purchase at least one of said plurality of shares; and,
allowing said first registered user to resell said purchased plurality of shares to said at least one additional user.

2. The real property ownership interest trading method of claim 1, in which said property information is collected using an electronic user interface.

3. The real property ownership interest trading method of claim 1, in which said plurality of property information is stored in a computer database.

4. The real property ownership interest trading method of claim 1, in which said evaluating step further comprises the steps of:
validating said plurality of property information by cross checking said plurality of property information with a plurality of other property information; and,
verifying the accuracy of said property information.

5. The real property ownership interest trading method of claim 1, in which the number of said plurality of shares assigned to said property is determined based on said analysis.

6. The real property ownership interest trading method of claim 1, in which the number of said shares assigned to said property is requested by a party responsible for entering said property information.

7. The real property ownership interest trading method of claim 1, in which said plurality of user information is collected through a computerized interface.

8. The real property ownership interest trading method of claim 1, further comprising the step of generating a share price evaluation.

9. The real property ownership interest trading method of claim 8, in which said evaluation is generated for said first registered user before said plurality of shares are purchased.

10. The real property ownership interest trading method of claim 8, in which said evaluation is generated for said first registered user before said plurality of shares are sold.

11. The real property ownership interest trading method of claim 1, further comprising the steps of:
receiving from said first registered user a price at which said first registered user wishes to pay for at least one of said plurality of shares and a quantity of shares which said first registered user desires to purchase;
notifying at least one owner of said property shares of said first registered user interest in purchasing said at least one of said plurality of shares and said quantity of shares desired;
allowing said share owners to accept or decline to sell at least one share to said registered user at the price specified by said registered user;
transferring funds for approved share purchases from said registered user to a share owner accepting said registered user share request; and
transferring ownership of approved shares from said accepting share owner to said registered user.

12. A method by which ownership interest in real property can be traded, comprising the steps of:
collecting a plurality of information about a property through a computerized user interface;
storing said property information in at least one computer database;
analyzing said plurality of property information;
validating said plurality of property information by cross checking said plurality of property information with a plurality of information stored in said at least one computer database; and,
verifying the accuracy of said property information;
assigning a number of shares to said property based on said analysis;
registering a first user by collecting a plurality of user information through a computer user interface;
registering at least one other user by collecting a plurality of user information through a computer user interface;
generating a share price evaluation when requested by said first registered user;
receiving from said first registered user a price at which said first registered user wishes to pay for at least one of said plurality of shares and a quantity of shares which said first registered user desires to purchase;
notifying at least one owner of said property shares of said first registered user interest in purchasing said at least one of said plurality of shares;
generating an evaluation of said first registered user purchase request when requested by any of said at least one share owners;
allowing said share owners to accept or decline to sell at least one share to said registered user at the price specified by said registered user;
transferring funds for accepted share purchases from said registered user to a share owner accepting said registered user share request; and
transferring ownership of transferred shares from said accepting share owner to said first registered user.

13. The real property ownership interest trading method of claim 12, in which said property value is collected with other property information and stored in said computer database.

14. The real property ownership trading method of claim 12, in which said property value is determined during said property information evaluation.

15. A real property ownership interest trading method, comprising the steps of:
receiving a plurality property information about a property from a representative;
storing said property information;
assigning a number of shares to said property;
assigning a value to each of said shares;
allowing said representative to select the initial property offering type;
allowing said representative to select at least one investor whom said representative will allow to invest in said property;
allowing said representative to specify the minimum and maximum number of shares each of said selected investors may purchase;
notifying said investors of the availability to invest in said property;
recording share purchase requests from said investors;
transferring funds from said investors to said representative and recording said funds transfer; and,
transferring ownership of shares purchased by said investors from said representative to said investors and recording said ownership transfer.

16. A modular computer software application for real property ownership interest trading, comprising:
a software module capable of receiving a plurality of property and a plurality of user information, and capable of storing said plurality of property and plurality of user information in a data storage means;
a software module capable of cross referencing a plurality of new property information against a plurality of property information stored in said data storage means;
a software module capable of verifying a plurality of new property information with at least one external source;
a software module capable of calculating a value for said property;
a software module which assigns a number of shares to a new property based on said calculated property value;
a software module which provides a user interface through which a user can enter one or more share purchase requests, and which stores said one or more share purchase requests in said data storage means;
a software module which provides a user interface through which share owners can evaluate said one or more share purchase requests, through which a share owner can accept or deny said one or more share purchase requests, and which records such acceptances or denials in said data storage means; and
a software module which transfers appropriate funds and shares between said share owner accepting said share purchase requests and said user entering said one or more share purchase requests, and records such transfers in said data storage means.

17. The real property ownership interest trading system of claim 16, in which said plurality of property and plurality of user information collection software module includes a computerized user interface.

18. The real property ownership interest trading system of claim 16, in which said data storage means is at least one computer database.

19. A real property ownership interest trading system, comprising:
a computerized property information collection means;
at least one computer database;
computer software which assigns a number of shares to property stored in said computer database based on information collected through said property information means;
computer software which cross references information stored in said computer database with information entered through said computerized property information collection means and validates said entered information;
at least one table in said computer database for storing user share bids and share owner bid acceptances;
at least one table in said computer database for recording share ownership.
